(19) United States
(12) Patent Application Publication
(10) Pub. No.: US 2005/0000705 A1
(43) Pub. Date: Jan. 6, 2005

(54) Sod pick-up mechanism

(76) Inventors: Gerardus J. Brouwer, Keswick (CA); Robert Milwain, Keswick (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/780,617

(22) Filed: Feb. 19, 2004

Related U.S. Application Data
(60) Provisional application No. 60/448,127, filed on Feb. 20, 2003.

(51) Int. Cl. A01B 79/00

(52) U.S. Cl. 172/19

(57) ABSTRACT

A sod pick-up mechanism for a sod harvester has in one embodiment a set of hooks mounted on rotatable shafts. The hooks can be rotated through a grid into sod rolls or sod slabs located below the grid, to penetrate the sod rolls or slabs and pin them to the underside of the grid, after which the set of rolls or slabs thus retained can be moved to an appropriate stacking location such as a pallet. In another embodiment arms press against the ends of the sod rolls exerting pressure on them to retain them for pick up. If desired, the sod rolls can be arranged e.g., in sets of three, end-to-end, in the form of an arch to prevent the middle roll from dropping out. Pins which penetrate the sod rolls can be used to help retain the sod rolls while they are being moved. Other embodiments comprise clamps for engaging sod rolls from opposite sides or ends and a sod slab pick-up arrangement comprising a first screen which engages the grass side of the slabs so that the grass projects through openings in the screen, and a second screen that engages the projecting grass and traps it between to the two screens.

### PRIOR APPLICATION

This application claims the benefit of U.S. Provisional Application Ser. No. 60/448,127, filed Feb. 20, 2003, entitled SOD PICK-UP MECHANISM.

### FIELD OF THE INVENTION

This invention relates to a mechanism for picking up rolls or slabs of sod which have been produced by a sod harvester, and for transferring the rolls or slabs onto a stack of sod rolls or slabs, usually formed on a pallet. The slabs may be flat or folded.

### BACKGROUND OF THE INVENTION

Sod harvesters for producing rolls or slabs of sod are well known. In these machines, the rolls or slabs of sod which are produced, are carried along a conveyor, and in the past, one or more persons would ride on the machines and would lift the rolls or slabs so produced and transfer them to a pallet. When the pallet was full, it would be discharged from the machine and stacking of a new pallet would begin.

This was obviously a very labour intensive process, and therefore various attempts have been made to create machines, which automatically stack rolls or slabs of sod on a pallet. In the past, such machines have been costly, complex and in many cases have not worked well.

### BRIEF SUMMARY OF THE INVENTION

It is therefore an object of the present invention to provide unique mechanisms for picking up pieces of sod delivered by a sod harvester, and for transferring these pieces (which may be rolls or slabs) onto a stack, which may be formed on a pallet or other appropriate support.

In one aspect, the invention provides a mechanism for picking up sod pieces and comprising a plurality of piercing members having pointed tips, a mounting mechanism for mounting said piercing members above said sod pieces, an actuating mechanism to actuate said piercing members for said tips to pierce said sod pieces and to support said sod pieces, and a moving mechanism for moving said sod pick-up device to a location for releasing said sod pieces onto a support.

In another aspect, the invention provides a sod pick-up mechanism for a sod roll, each sod roll having side surfaces and ends, said mechanism comprising at least one clamp device including a pair of arms engageable with opposite side surfaces or ends of a roll to clamp said roll, and a motive device carrying said clamp device for moving said clamp device to a location for releasing said sod roll onto a support.

In another aspect, the invention provides a sod pick-up mechanism for a set of sod rolls, said set having side surfaces and end surfaces, said mechanism comprising at least one clamp device including a pair of arms engageable with opposite said side surfaces or said end surfaces of said set, and a motive device carrying said clamp device for moving said clamp device to a location for releasing said set of sod rolls onto a support.

Further objects and advantages of the invention will appear from the following description, taken in conjunction with the accompanying drawings.

### BRIEF DESCRIPTION OF THE DRAWINGS

In the drawings:

FIG. 1 is a diagrammatic schematic view of the main components of a prior art sod harvester with which the invention may be used;

FIG. 2 is a diagrammatic perspective view showing how a prior art sod pick-up mechanism is used to stack sod rolls on a pallet;

FIG. 3 is a perspective view showing a portion of a hook mechanism of a sod pick-up mechanism according to a first embodiment of the invention;

FIG. 4 is a perspective view from below of the sod pick-up mechanism of FIG. 3 showing such mechanism lifting fifteen sod rolls;

FIG. 5 is a perspective view from above the sod pick-up mechanism of FIG. 4, showing the hooks ready to penetrate sod rolls which are below the mechanism;

FIG. 6 is a perspective view similar to that of FIG. 5 but showing the hooks partly penetrating the sod rolls;

FIG. 7 is a side view showing the hooks partly penetrating the sod rolls of the FIGS. 4 to 6 mechanism;

FIG. 8 is a top view showing diagrammatically a portion of a conveyor for cooperation with the hook mechanism of FIGS. 4 to 7;

FIG. 9 is a perspective view of a portion of a prior art sod harvesting mechanism showing a sod slab ready to be handled;

FIG. 10 is a perspective view of a second embodiment of the invention showing hooks penetrating the sod slabs of FIG. 9;

FIG. 11 is a side view of the mechanism of FIG. 10 showing the sod slabs lifted by the hooks of the mechanism, with the hooks shown projecting through the slabs—though the hooks may engage in the soil portion only and not project through the slabs;

FIG. 12 is a perspective view from below showing the sod slabs lifted by the hooks of the FIGS. 10, 11 mechanism;

FIG. 12A(i) is a diagrammatic side view showing how sod may be picked up using hooks and a screen in accordance with the first embodiment of the invention;

FIG. 12A(ii) is a diagrammatic side view similar to FIG. 12A(i) but showing a different manner of using the hooks;

FIG. 12A(iii) is a diagrammatic side view similar to FIG. 12A(i) but showing hooks engaging into the sod slab from opposite directions;

FIG. 12A(iv) is a side view showing a folded sod slab;

FIG. 12A(v) is a diagrammatic side view similar to FIG. 12A(i) but showing the hooks engaging into sod rolls;

FIG. 12A(vi) is a diagrammatic side view similar to FIG. 12A(i) but showing a modified use of hooks and a screen to engage a sod slab;

FIG. 13A is a perspective view of another embodiment of a sod pick-up mechanism according to the invention;

FIG. 13B is a side view of the sod pick-up mechanism of FIG. 13A;

FIG. 14A is a diagrammatic side view of a modified version of the mechanism of FIG. 13A;

FIG. 14B is a diagrammatic sectional view of a sod storage conveyor for receiving and storing sod rolls prior to pick-up;

FIG. 14C is a view similar to FIG. 14B but showing the sod storage conveyor in the form of an arch;

FIG. 15 is a perspective view of an alternative set of arms for the pick-up mechanism of FIGS. 13 and 14;

FIG. 16 is a perspective view showing a modification of a portion of the mechanism of FIGS. 13A, 13B, using angled pins;

FIG. 17 is a perspective view similar to that of FIG. 16, and showing another modification of the FIGS. 13A, 13B, mechanism;

FIG. 18(a) is a side view of a set of sod rolls with angled pins projecting into them longitudinally;

FIG. 18(b) is an end view of a pair of sod rolls with a pair of pins projecting into them radially;

FIG. 18(c) is a side view of a sod roll with one angled pin projecting into it axially;

FIG. 19(a) is an end view of a sod roll with a hook penetrating into the side of the roll and extending through the roll to a position adjacent its upper surface;

FIG. 19(b) is a view similar to FIG. 19(a) but with the hook penetrating in the opposite direction;

FIG. 19(c) is a view similar to FIG. 19(a) but with the hook penetrating only partially into the roll;

FIG. 19(d) is a diagrammatic perspective view showing a hook penetrating longitudinally into a sod roll;

FIG. 20 is a diagrammatic side view showing a modification of the FIGS. 14A to 14C mechanism;

FIG. 21(a) is a diagrammatic perspective view showing sets of clamps in position to pick up a line of sod rolls;

FIG. 21(b) is an end view showing a pair of clamps in position to discharge a sod roll beside other sod rolls;

FIG. 21(c) is a side view showing a pair of arms in position to pick up a sod roll;

FIG. 21(d) is a plan view of one of the arms of FIG. 21(c);

FIG. 21(e) is a view similar to FIG. 21(c) but showing modified clamping arms;

FIG. 21(f) is a view similar to FIG. 21(c) but showing further modified clamping arms;

FIG. 21(g) is a view similar to FIG. 21(c) but showing still further modified clamping arms;

FIG. 21(h) is a plan view of a set of sod rolls arranged side-by-side with a pair of spring-aided clamping arms; and

FIG. 21(i) is a plan view of several lines of side-by-side sod rolls with two clamping arms to pick up all of the sod rolls.

### DETAILED DESCRIPTION OF THE PREFERRED EMBODIMENT

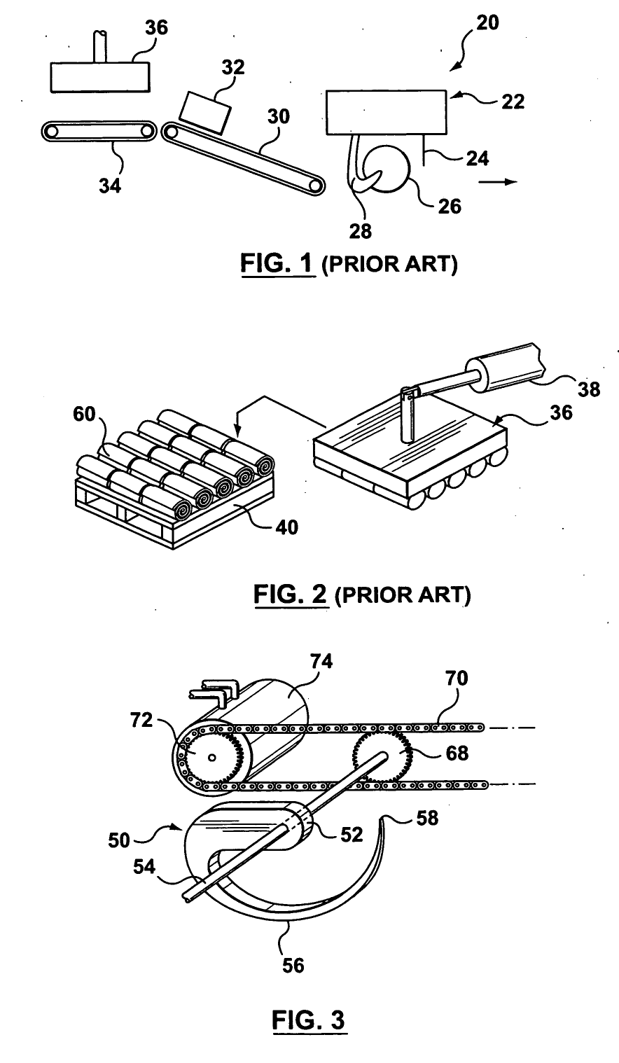

Reference is first made to FIG. 1, which shows diagrammatically the main elements of a conventional prior art tractor mounted sod harvester 20. The sod harvester 20 includes a cutting head 22 having a cross cut knife 24, a roller 26, and an undercutting knife 28 to undercut and side cut strips of sod being harvested.

The strips of sod travel rearwardly and upwardly along a conveyor 30, on which (assuming that rolls are to be produced) they are formed into rolls by a roll up mechanism 32. The resultant sod rolls are then discharged rearwardly onto a sod roll storage or accumulator conveyor 34. From the storage conveyor 34, the sod rolls are picked up by a sod roll pick-up mechanism 36 for transfer to a pallet or the like. The harvester shown and described in FIG. 1 is conventional and is well known to those skilled in the art.

As shown in FIG. 2, the sod roll pick-up mechanism 36 includes a motor indicated diagrammatically at 38 which powers the movement needed to transfer the sod rolls to a pallet 40, as is well known.

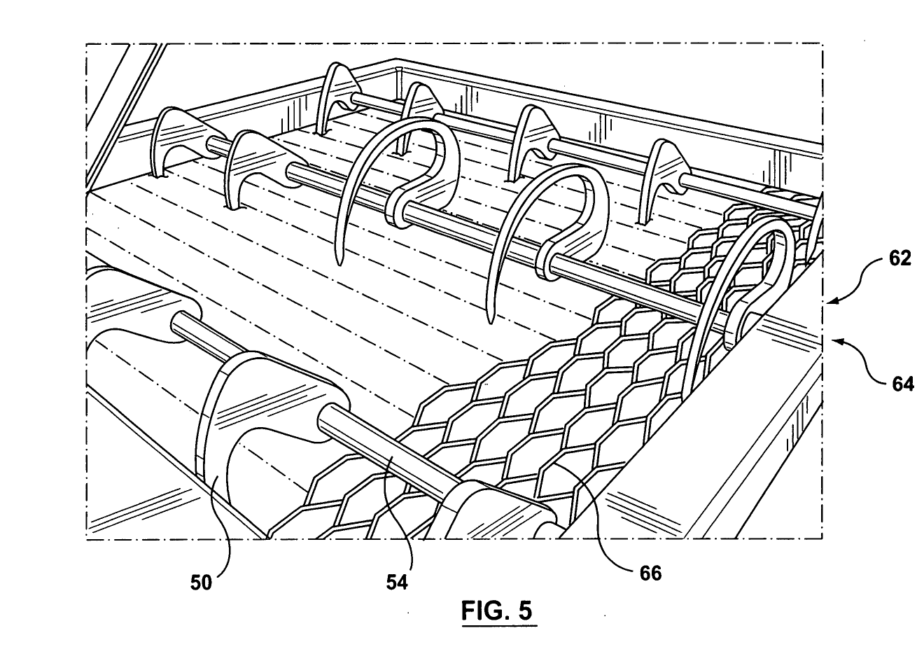

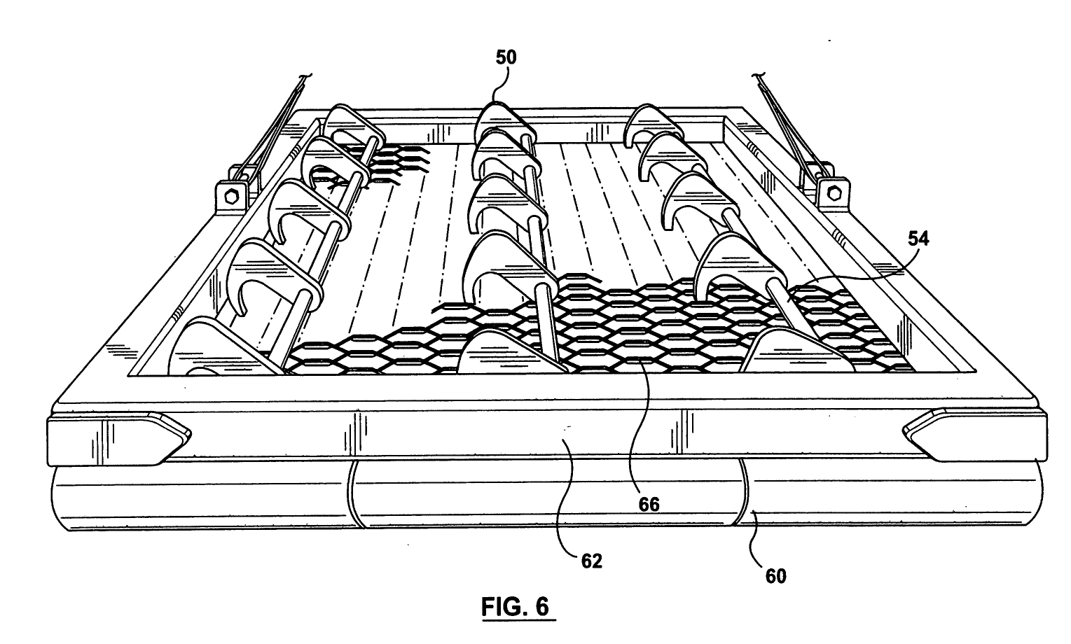

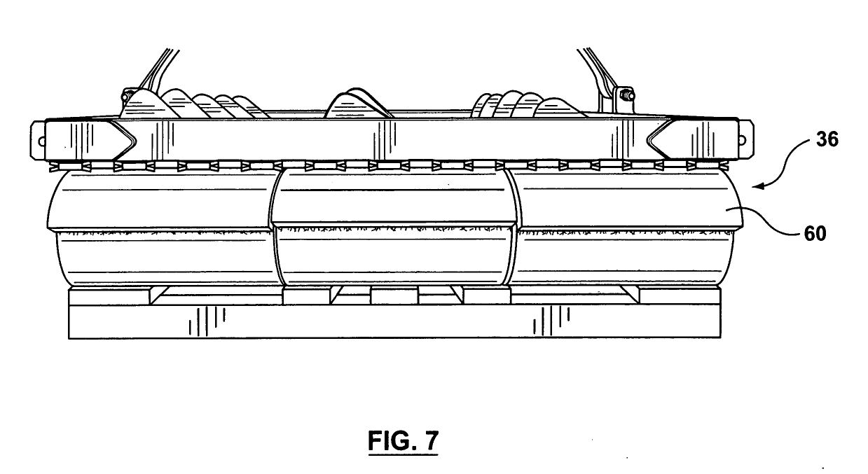

The present invention is concerned with a new design for the sod roll pick-up mechanism 36. Reference is next made to FIGS. 3 to 7, which show a first embodiment of a sod roll pick-up mechanism 36 according to the invention. As shown, the mechanism 36 includes a set of hooks 50, each hook having a base 52 mounted on a transverse shaft 54, and a tapered pointed curved hook portion 56 which extends around a 180° arc and ends in a pointed tip 58 which is spaced in a front to rear direction from the base 52. There may be only a single hook 50 for each sod roll 60, although typically two or more hooks per roll will be used. As shown in FIGS. 5 and 6, a number of hooks 50 are mounted on each shaft 54.

As shown, the shafts 54 extend across and are mounted in side frame members 62 of a frame 64, above a screen or grid 66, which extends across the frame 64. The shafts 54 each carry at their ends a sprocket 68, which is operated by a chain 70. The chain 70 is driven by a sprocket 72 actuated by a hydraulic or electric motor 74. An alternative is to use a mechanical linkage actuated by a hydraulic cylinder.

As will be evident from the drawings, a set of sod rolls may be delivered to the sod roll storage device 34. Typically fifteen sod rolls may be so delivered, by a three head harvester. (Alternatively a smaller number may be delivered if desired. For example one or two lines of sod rolls, arranged end-to-end or side-by-side, may be delivered.) The frame 64 is then lowered onto the sod rolls 60 located on the storage device 34, with the hooks 50 rotated so that their tips 58 are located above the screen 66. The motor 74 is then operated to turn the shafts 54 to rotate the hooks 50, thus causing the hooks to penetrate the sod rolls 60. Preferably, the penetration is such that the tips 58 exit or nearly exit from the top of the sod rolls (passing through the screen 66 during this process), but this is not essential. The hooks 50 thus retain the sod rolls 60 securely against the underside of the screen 66 at this time. For this purpose the screen 66 is made of a strong material, e.g., expanded metal.

Preferably, the screen 66 pushes down on the sod before or while the hooks are actuated. This ensures that the sod is held firmly when lifted. Also, the screen provides resistance to movement of the sod when the hooks are withdrawn.

The pick-up mechanism 36 is then operated to move the accumulated sod rolls to a pallet such as pallet 40, whereon they are discharged in the desired orientation to build a stack of sod rolls on the pallet.

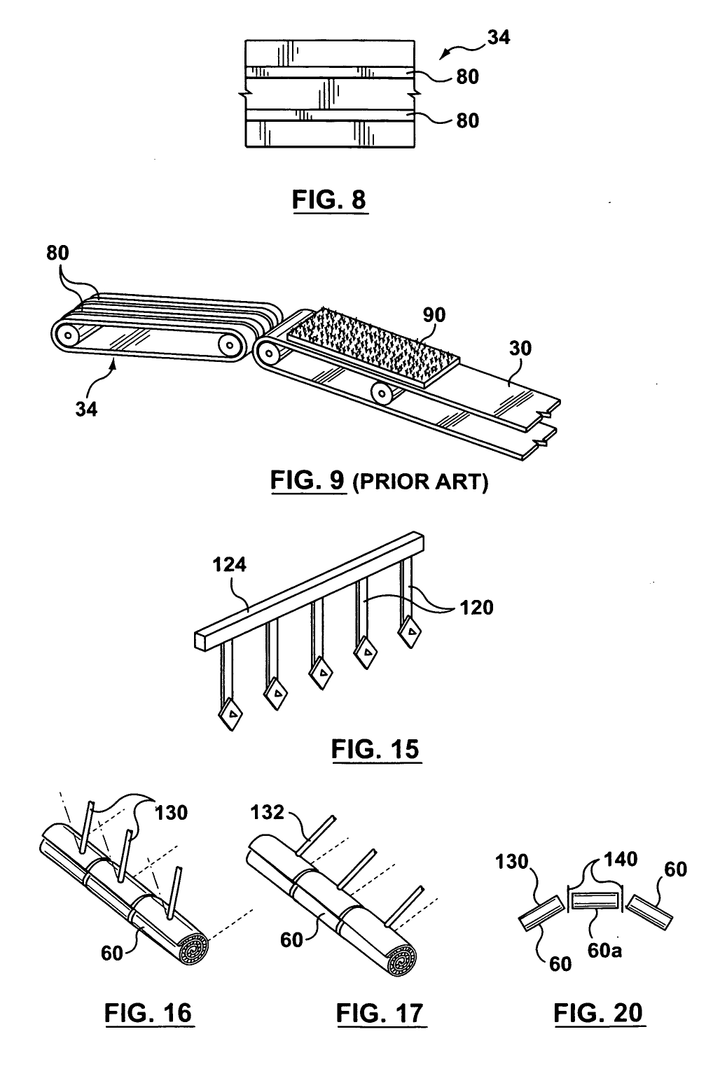

When the hooks 50 are penetrating the sod rolls 60, it is possible that they may emerge through the bottoms of the sod rolls, although this is unlikely. However, in case it occurs, the storage conveyor 34 may, as shown in FIG. 8, be formed with grooves or slots 80 therein, to allow penetration of the hooks.

Reference is next made to FIG. 9, which shows the conveyor 30 of FIG. 1 but with a sod slab 90 thereon. For this arrangement, the conveyor slots 80 will normally be required. However, the mechanism can be designed so that the hooks do not penetrate fully through the slab, in which case the slots 80 are not necessary.

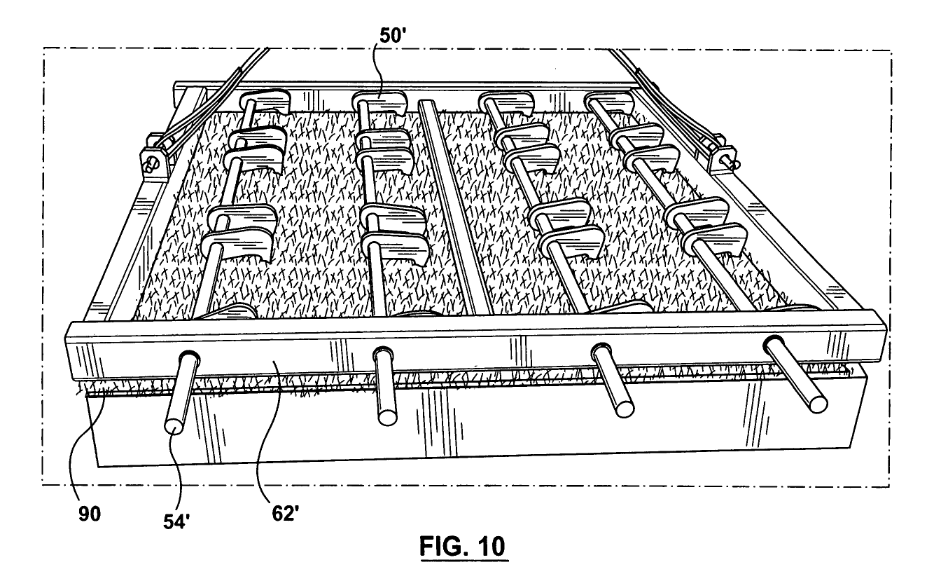

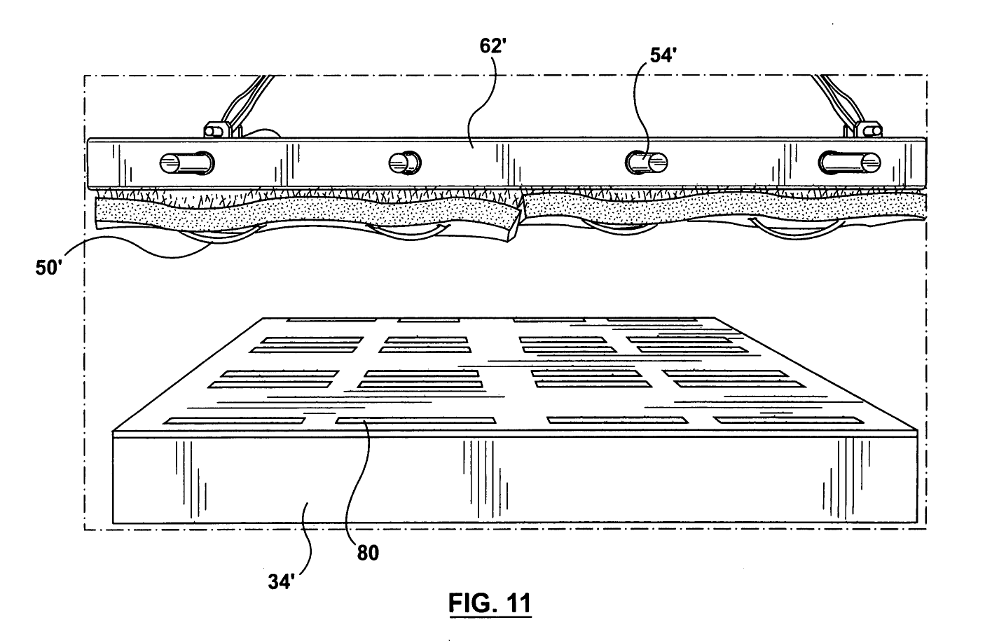

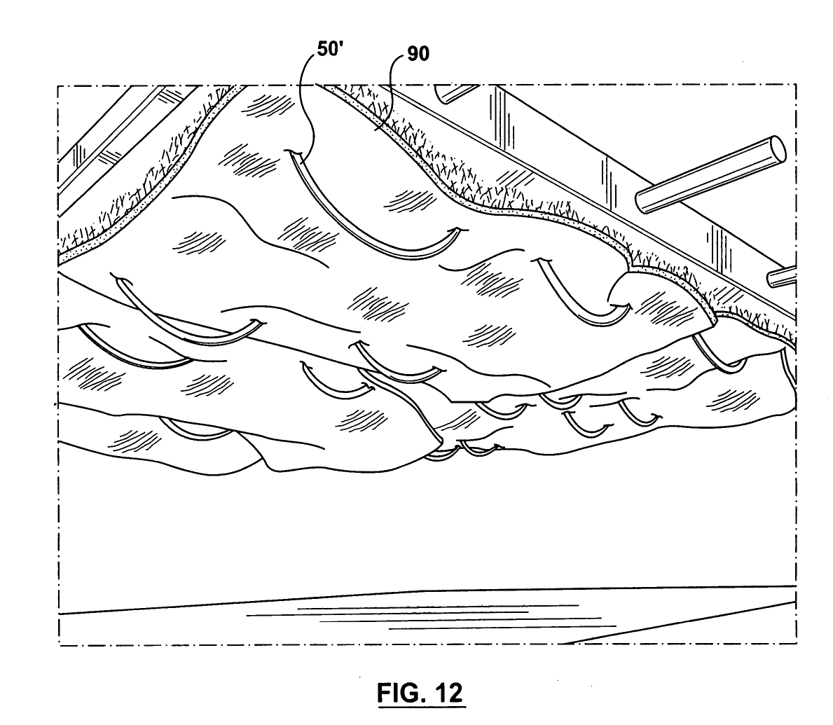

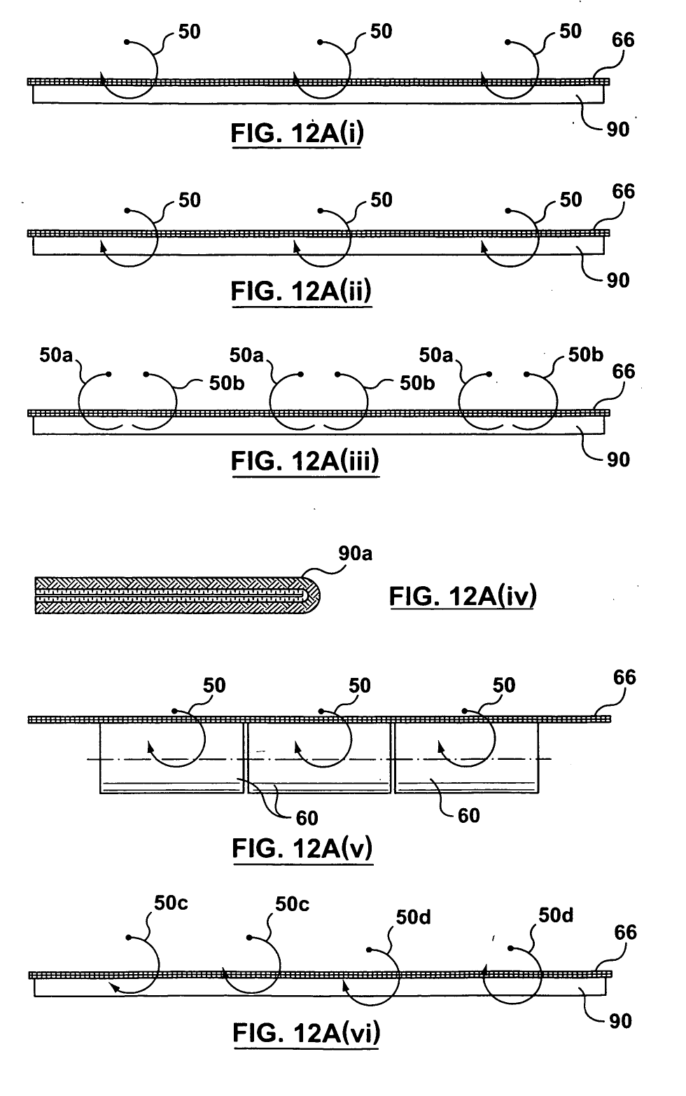

A pick-up mechanism for the sod slabs 90 is shown in FIGS. 10 to 12, where primed reference numerals indicate parts corresponding to those of FIGS. 1 to 8. As shown in FIGS. 10 to 12, hooks 50, which will be smaller than hooks 50 used for the sod rolls, are used to pick up the sod slabs 90 and to pin the slabs to the underside of screen 66. Typically two or more hooks per slab will be used. As shown, the hooks will penetrate through the sod slabs and will project below the slab, thus requiring the slots 80 in the storage conveyor 34. As noted above, the mechanism can be designed so that the hooks do not project through the slab; in which case slots 80 are unnecessary. The various possibilities are diagrammatically summarized in FIGS. 12(A)(i) to 12(A)(vi).

In FIG. 12(A)(i), a number of the hooks 50 are mounted on the shaft 54 (as before) and are shown as extending through screen 66 and engaged in sod slab 90. The sod slab 90 is shown as being a single layer, not folded. The hooks 50 penetrate the sod slab 90 and extend back through screen 66 and protrude above the screen. However the hooks 50 do not go through the bottom of the slab 90, so that there is no need for a groove in a conveyor supporting the slab 90.

FIG. 12(A)(ii) shows the same arrangement as FIG. 12(A)(i), except that the hooks 50 now extend below the bottom of the sod slab 90. In this arrangement there will be a need for a groove in the upper surface of the conveyor (not shown) supporting the sod slab 90.

FIG. 12(A)(iii) shows an arrangement in which the hooks 50 are arranged in pairs 50a, 50b, counter-rotating in opposite directions and supporting a single layer sod slab 90. This arrangement is more complex than having the hooks all rotate in the same direction, since it is no longer possible to use a single shaft rotating in one direction to move all of the hooks. Instead, coaxial shafts or two separate shafts, or a different mechanism, will be needed. However the counter-rotating hooks 50 have some advantages in certain applications.

FIG. 12(A)(iv) simply shows a folded sod slab 90a. In practice, the hooks 50 will penetrate both the top layer and also the bottom layer of slab 90a and can if desired extend below the bottom layer.

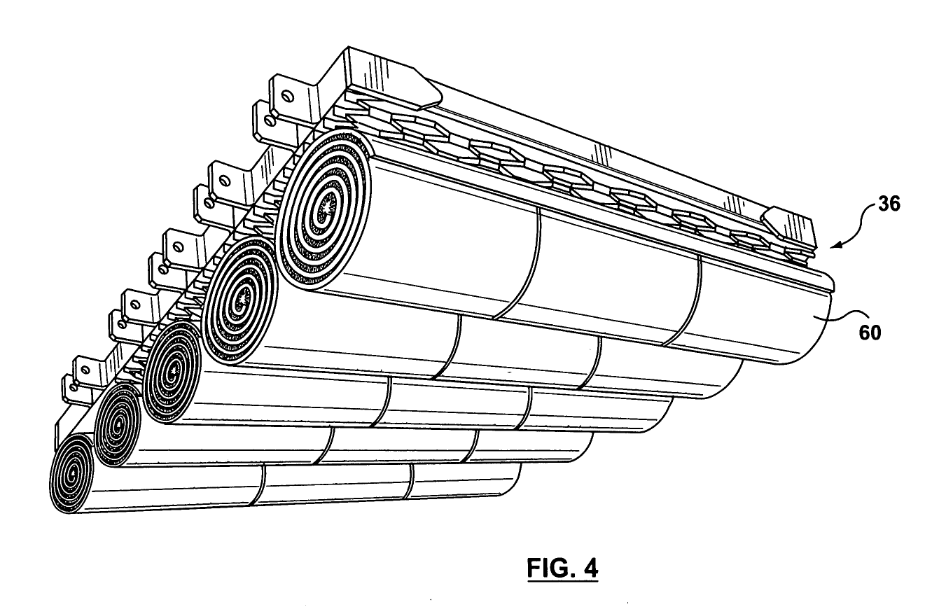

FIG. 12(A)(v) shows an arrangement much as shown in FIG. 4, with hooks 50 extending through the screen or mesh 66 and supporting sod rolls 60. In this case only a single hook per sod roll is used.

FIG. 12(A)(vi) shows an arrangement similar to that of FIG. 12(A)(v) except that the sod being supported is a slab 90 rather than rolls 60. FIG. 12(A)(vi) shows the use of small hooks 50c which can penetrate the slab 90 and extend back up to the screen 66 or above it. FIG. 12(A)(vi) also shows the use of larger hooks 50d which can extend below the bottom of the sod slab 90 and then extend back up to or above the screen 66.

In all cases in FIG. 12(A)(i) to 12(A)(vi), the sod is held against the screen 66 both when the hooks 50 have penetrated the sod, and when the structure is being moved to stack the sod, and while placing the sod on the pallet or other support (to hold the sod there while the hooks are being retracted).

It is important to note that, in accordance with the first embodiment of the invention, it is possible to pick up a layer of sod rolls (for example 15 rolls—5×3) using one hook in each sod roll. This has not previously been possible. As mentioned, once the sod slabs have been pinned to the underside of the screen 66′, they can be moved to a desired location and stacked.

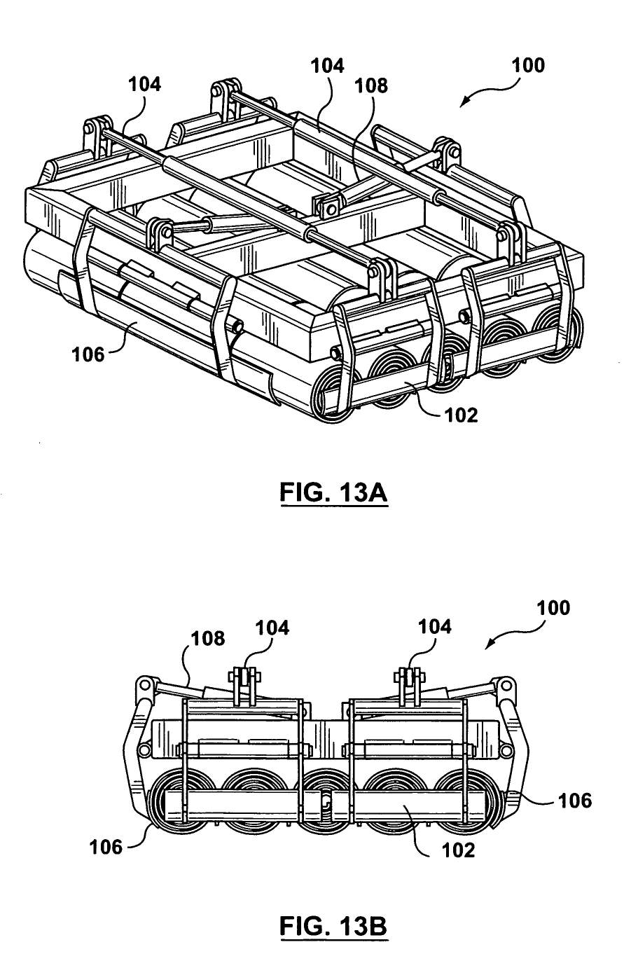

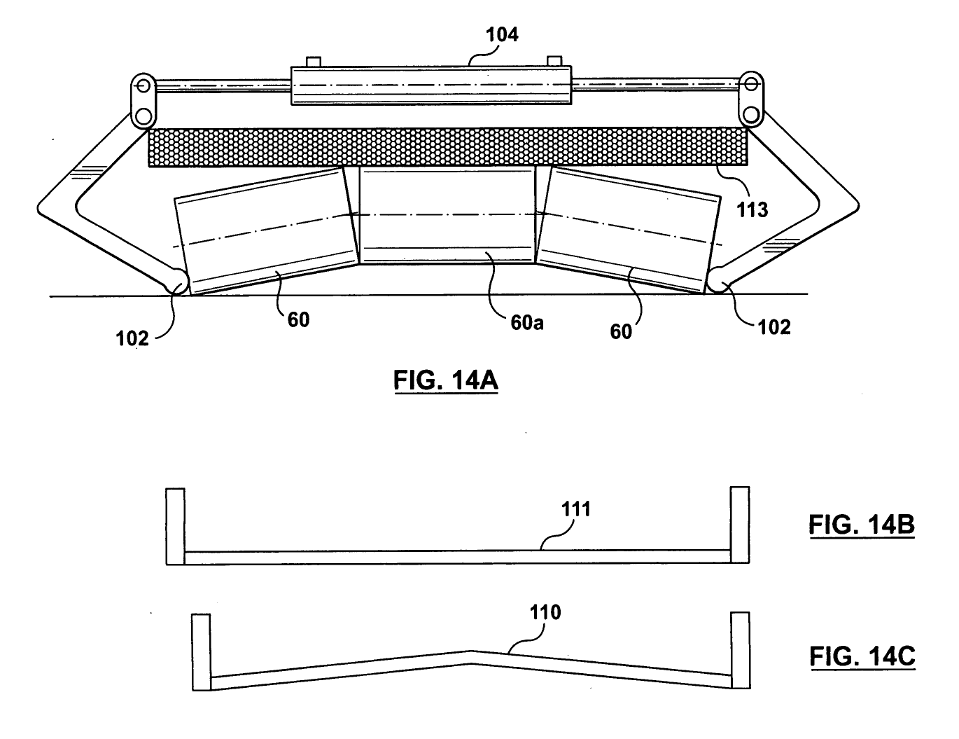

Reference is next made to FIGS. 13A, 13B and 14A to 14C, which show another embodiment of the invention. As shown, a set of sod rolls 60 (typically a three by five set) accumulated on the sod roll storage conveyor (not shown) may be picked up by a sod roll pick-up mechanism 100 which includes a pair of pressure end plates 102 which, actuated by a pair of piston and cylinder mechanisms 104, can press firmly against opposing ends of each end-to-end set of three sod rolls to exert axial pressure on the sod rolls. At the same time, side plates 106, actuated by a piston and cylinder mechanism 108, press against the sides of each outer set of three sod rolls to prevent them from buckling outwardly. The mechanism 100 can then lift the set of sod rolls and move them to a desired location. Side plates 106 are not always necessary.

To help ensure that the end plates 102 hold the sod rolls firmly, without having the middle rolls in each set of three end-to-end rolls dropping out, the floor (which may be a conveyor) of the sod roll storage mechanism 34 can be configured in the form of an arch 110, as shown in FIG. 14C, rather than being flat as shown at 111 in FIG. 14B. When the sod rolls 60 are compressed at each end in the form of an arch (FIG. 14A), with the middle roll 60a pushed up against the “roof” 113 of the clamping mechanism and blocked from further upward movement by that “roof”, it becomes virtually impossible for the middle roll 60a to drop out, so that the rolls are held more securely. (The number of sod rolls arranged end-to-end can of course vary and can be more or less than three.)

If desired, instead of a continuous side plate 102, individual side arms 120 can be used, a pair for each end-to-end set of sod rolls, as shown in FIG. 15. The arms 120 at each end of the sod rolls are mounted on a single shaft 124 which is actuated by the piston and cylinder mechanism 104. Arms 120 may or may not incorporate spring biasing means.

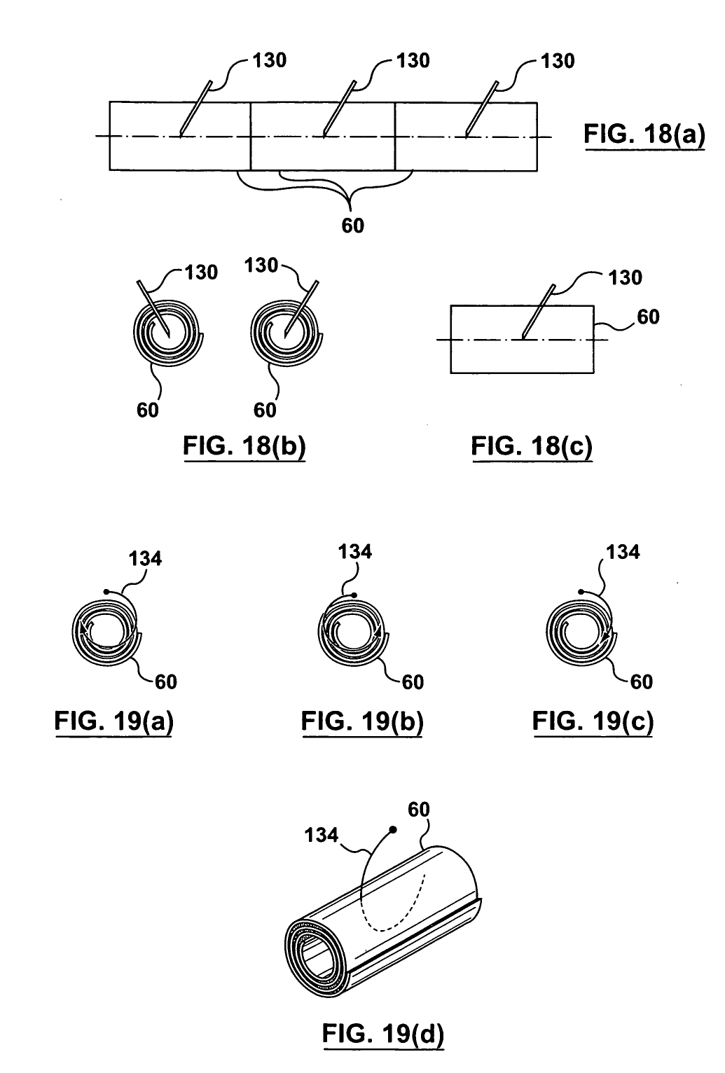

As shown in FIG. 16, and if desired, instead of picking up the sod rolls by using the side plates 102 and end plates 106, a set of pins 130 can be used to penetrate the sod rolls 60, much like the hooks previously described. The pins 130 can be inserted downwardly into the sod rolls as shown in FIG. 16, on an angle as shown at 132 in FIG. 17, or horizontally into the sides of the rolls. In any event, the pins should be angled with respect to the longitudinal axis of the sod rolls in order to reduce the risk of the pins simply pulling out when the rolls are lifted. Examples of this are shown in FIGS. 18(a), 18(b) and 18(c). In FIG. 18(a), the pins 130 are shown as simply angled with respect to the longitudinal axis of the sod rolls 60. In FIG. 18(b), the pins 130 are shown as angled radially and penetrating the sides of the sod rolls 60. In FIG. 18(c) a single pin 130 is shown penetrating the top of a sod roll 60 and as being angled with respect to that sod rolls longitudinal axis.

As will be understood from the previous description, the pins 130 or 132 can be replaced by hooks 134 as shown in FIGS. 19(a), 19(b) or 19(c). The hooks 134 engage each roll 60 radially from the top or side as shown, or longitudinally as shown in FIG. 19(d).

Friction plates 140 can be used between the ends of the sod rolls 60, as shown in FIG. 20, in conjunction with the side plates 102 and end plates 106. The friction plates 140 (which extend downwardly from the frame of the sod pick-up mechanism) help to retain the sod rolls in position. Alternatively, or in addition, the pins 130 can be used in the FIG. 20 mechanism, as in the FIGS. 13 and 14 mechanism, but in this case the pins would normally be used only on the center rolls of each set of three end-to-end rolls.

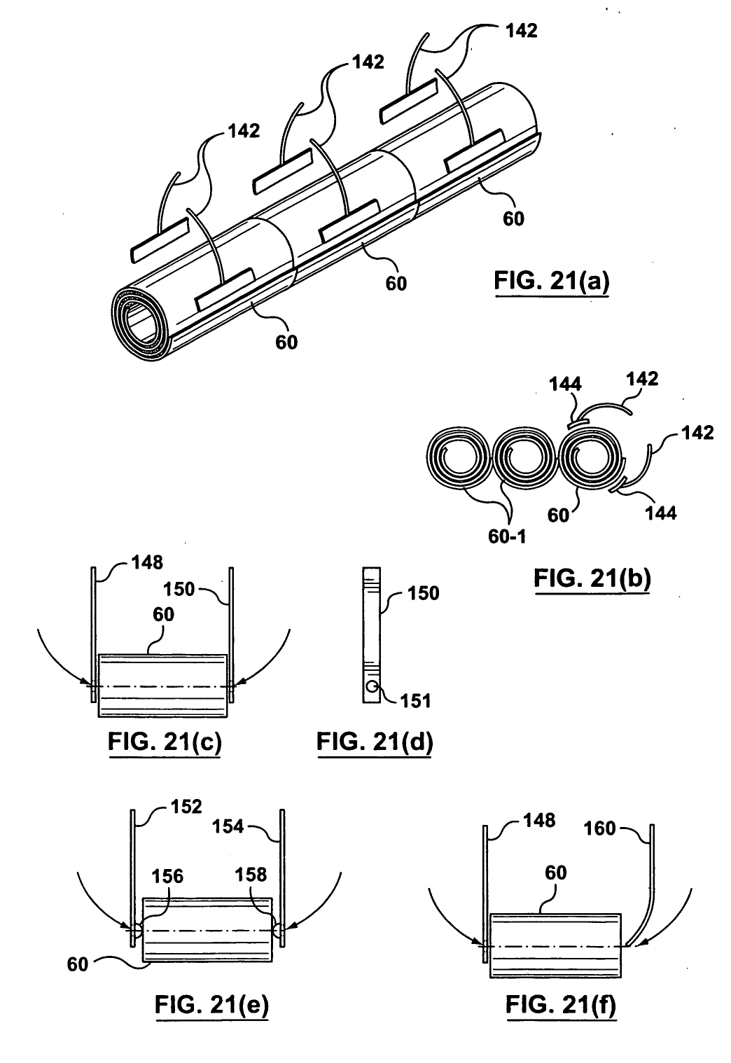

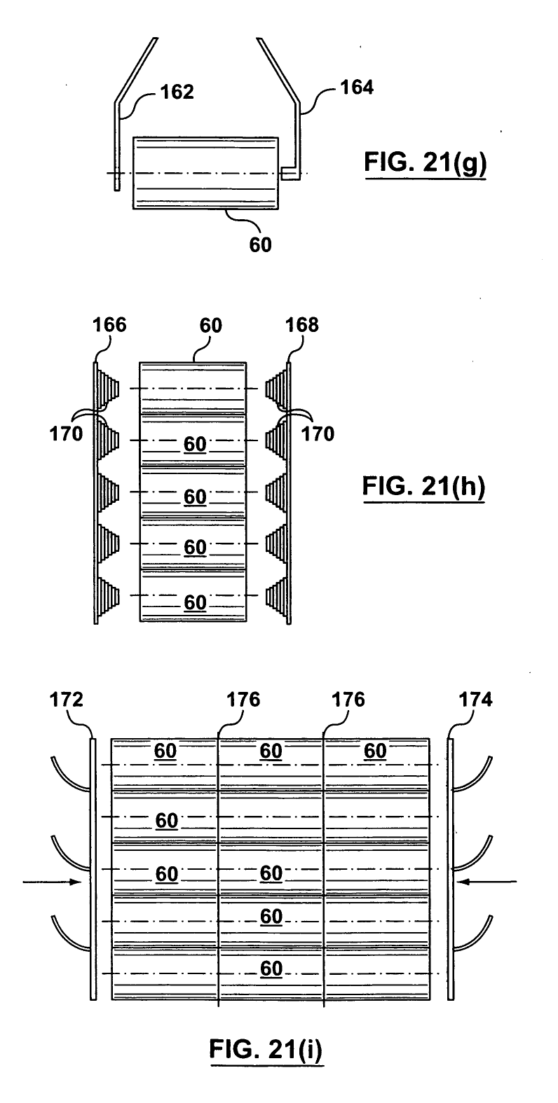

FIG. 21 illustrates further embodiments of the invention, in some of which sets of clamps are used to pick up single rows of sod rolls. As seen in FIG. 21(a), three sets of clamps are shown and are individually denoted 142 for picking up three rolls of sod 60. The clamps 142 engage the sides of the sod rolls 60. Means for clamping, unclamping the sets of clamps 142 and for lifting the clamps (with or without the sod rolls gripped by the clamps) are not shown but are conventional and well known to those skilled in the art. (Of course the number of sod rolls lifted can be more or less than three.)

FIG. 21(b) shows that the clamps 142 may be offset angularly about the axis of a sod roll 60, to facilitate stacking of the roll against the side of an earlier stacked roll 60-1. The roll-engaging ends of the respective clamps can be of various forms. For example, the top arm of the clamp can be provided with a pad, fork or pin 144, while the equivalent on the lower arm (146) could be the same but more usually will be a pad.

FIG. 21(c) shows a variation in which a pair of relatively thin clamp arms 148 and 150 are used to engage respectively opposite ends of a sod roll 60. The portions of the end of the arms 148 and 150 that contact the roll may be provided with openings as shown at 151 in FIG. 21(d). Blades of grass and/or other portions of the roll 60 may project through the openings 151 so as to aid in retention of the sod roll 60 between the arms 148, 150. The fact that the arms 148, 150 are thin makes it easier to stack a roll that is being picked up closely adjacent a previously stacked roll. The arms 148, 150 may be mechanically moveable in and out to engage and disengage a roll, may be spring-biased or otherwise designed to pick up and release a roll. For example, FIG. 21(e) shows an embodiment in which arms 152, 154 are provided with special formations 156, 158 respectively (essentially inwardly projecting “bumps”) that provide pressure points for engaging the roll 60. FIG. 21(f) shows an embodiment in which the end of one arm 160 is curved inwardly to engage the roll.

FIG. 21(g) shows an embodiment in which one arm 162 is relatively flat where it engages the roll, whereas the other arm 164 angles inwardly and may in fact protrude into the roll 60. This embodiment again facilitates stacking against earlier stacked rolls by arranging for the arm 162 to be located adjacent the earlier stacked roll.

FIG. 21(h) shows an embodiment in which respective arms 166 and 168 engage a row of sod rolls 60 through the intermediary of spring-biased roll contact devices 170. The spring contact devices 170 are shown diagrammatically as coil springs, but the springs can be encased in rubber, or spring-like rubber bladders can be used, or other spring-like devices so as to provide pressure against the ends of the sod rolls 60 and accommodate variations in the lengths of the sod rolls. If desired, spring-biased devices 170 can be provided at one side only of the roll of sod rolls, e.g. on arm 166, so that the arm 168 on the opposite side can again be relatively thin for ease of positioning against an earlier stacked set of sod rolls. The arms 166, 168 may be common arms for all of the rolls, or individual arms may be provided, one for each roll.

FIG. 21(i) shows an arrangement in which multiple rows of sod rolls 60 can be clamped between two arms 172, 174 and in which friction plates 176 are provided between the center roll and the outer rolls to prevent the center row dropping out when the rolls are lifted. These plates 176 provide a similar function to the plates 140 described in connection with the embodiment of FIG. 20.

While the various embodiments of the invention have been described as for lifting sod from a storage device for stacking on a pallet, they can also be used to pick sod up from a pallet or any other location, for laying the sod or for any other appropriate purpose.

It will be appreciated that modifications may be made to the invention described.

1. A mechanism for picking up sod pieces and comprising a plurality of piercing members having pointed tips, a mounting mechanism for mounting said piercing members above said sod pieces, an actuating mechanism to actuate said piercing members for said tips to pierce said sod pieces and to support said sod pieces, and a moving mechanism for moving said sod pick-up device to a location for releasing said sod pieces onto a support.

2. Apparatus according to claim 1 wherein said piercing members are hooks.

3. Apparatus according to claim 2 and including a screen below said hooks, said screen having openings therein and said tips of said hooks being sized to penetrate through said spaces for said hooks to pin said sod pieces to said screen, and for said screen to resist movement of said sod pieces while said hooks are being withdrawn from said sod pieces through said screen.

4. Apparatus according to claim 2 wherein said sod pieces are slabs.

5. Apparatus according to claim 4 wherein said slabs are folded.

6. Apparatus according to claim 2 wherein said sod pieces are rolls.

7. Apparatus according to claim 6 wherein said rolls are positioned end-to-end to form a line of rolls.

8. Apparatus according to claim 7 and including a plurality of said lines of rolls positioned side-by-side.

9. Apparatus according to claim 6 and having one hook per roll.

10. Apparatus according to claim 6 and including at least two hooks per roll.

11. Apparatus according to claim 10 wherein said actuating mechanism moves said two hooks of each roll in opposite directions so that said hooks close in a pincers movement.

12. Apparatus according to claim 2 wherein a plurality of said hooks are mounted on a shaft, and said actuating means is adapted to rotate said shaft.

13. Apparatus according to claim 2 wherein said hooks are sized to penetrate through said sod pieces and to project therebelow, said apparatus including a conveyor to support said sod pieces, said conveyor having an upper surface having grooves therein to accommodate said hooks.

14. A sod pick-up mechanism for a sod roll, each sod roll having side surfaces and ends, said mechanism comprising at least one clamp device including a pair of arms engageable with opposite side surfaces or ends of a roll to clamp said roll, and a motive device carrying said clamp device for moving said clamp device to a location for releasing said sod roll onto a support.

15. Apparatus according to claim 14 and including an upper sod locking member, said arms being located to press against said ends of one or more sod rolls for holding said one or more said sod rolls against said upper sod blocking member.

16. Apparatus according to claim 14 and including a plurality of said pairs of side arms for picking up a plurality of said sod rolls.

17. Apparatus according to claim 16 wherein each sod roll has an axis, said arms being located to pick up an axial line of said sod roll.

18. Apparatus according to claim 14 and adapted to pick up a line of sod rolls having their respective side surfaces abutting, said apparatus including a plurality of said pairs of side arms, said side arms having cushioned gripping portions to accommodate irregularities in the length of said sod rolls.

19. Apparatus according to claim 14 wherein one of said side arms is substantially straight and is a friction side arm, and the other said side arm has a projection thereon for gripping an end of said sod roll.

20. Apparatus according to claim 14 wherein said side arms each have a plate member thereon for gripping a side of said sod roll.

21. Apparatus according to claim 20 wherein said plate members of said side arms are positioned to grip said sod roll at diametrically opposite positions on said sod roll.

22. Apparatus according to claim 20 wherein one of said plate members is positioned to grip a side of said sod roll at substantially the center of the vertical height of the said sod roll, and the other plate member is positioned to grip said sod roll at a position adjacent the upper surface of said sod roll, whereby to facilitate gripping said sod roll when said sod roll is positioned in abutment against another sod roll.

23. A sod pick-up mechanism for a set of sod rolls, said set having side surfaces and end surfaces, said mechanism comprising at least one clamp device including a pair of arms engageable with opposite said side surfaces or said end surfaces of said set, and a motive device carrying said clamp device for moving said clamp device to a location for releasing said set of sod rolls onto a support.

24. Apparatus according to claim 23 wherein said pair of arms includes pressure plates engageable with said opposite side surfaces of said set, said mechanism including a further clamp device having a second pair of arms engageable with said opposite end surfaces of said set, so that both said side surfaces and said end surfaces are gripped by said clamp devices.
